(19) United States
(12) Patent Application Publication
(10) Pub. No.: US 2013/0024033 A1
(43) Pub. Date: Jan. 24, 2013

(54) SYSTEMS AND METHODS FOR A POWER DISTRIBUTION TRANSFER CAPACITY CALCULATOR

(71) Applicants: Hua Fan, Norcross, GA (US); Prashant Sharma, Cumming, GA (US); Robert Michael Lewkovich, Smyma, GA (US); Shitanshu Srivastava, Smyma, GA (US)

(72) Inventors: Hua Fan, Norcross, GA (US); Prashant Sharma, Cumming, GA (US); Robert Michael Lewkovich, Smyma, GA (US); Shitanshu Srivastava, Smyma, GA (US)

(73) Assignee: General Electric Company, Schenectady, NY (US)

(21) Appl. No.: 13/187,336

(22) Filed: Jul. 20, 2011

(51) Int. Cl. G06F 1/30

(52) U.S. Cl. 700/291

(57) ABSTRACT

In an embodiment, a method includes determining a path between a power source and a tie switch in a feeder within a model of a power distribution network. The method also includes determining one or more ratings respectively associated with one or more transformers located on the path. The method also includes determining one or more loads respectively associated with the one or more transformers located on the path. The method also includes determining one or more available capacities respectively associated with the one or more transformers based, at least in part, upon the one or more ratings and the one or more loads respectively associated with the one or more transformers. The method also includes assigning an available capacity to the tie switch in the model based, at least in part, on the one or more available capacities respectively associated with the one or more transformers, such that the model indicates how much power may be supplied by the feeder, upon activation of the tie switch, to restore power to a portion of the power distribution network.

### BACKGROUND OF THE INVENTION

The subject matter disclosed herein relates to power distribution networks and, more specifically, to power restoration in power distribution networks.

Utility companies distribute power from power sources to consumers using power distribution networks. Power distribution networks are generally divided into sections, referred to as feeders, which generally include a power source, transformers, and transmission lines. A feeder may also include a tie switch that may segment the feeder from other feeders in the power distribution network. The tie switch of a feeder may be closed in order for one feeder to receive power from, or supply power to, another feeder in the power distribution network.

For example, under certain circumstances, a fault may occur within a first feeder in a power distribution network, causing a portion of the first feeder to deenergize. As such, it may be desirable to have a second feeder supply power to a deenergized portion of the first feeder by closing the tie switches that separate the first and second feeders. However, simply connecting the second feeder to the first feeder via the tie switch could result in the failure of the second feeder under certain conditions. Distribution power flow (DPF) simulation systems may allow computer simulations of the first and second feeders to ensure the second feeder can support the first feeder. Such DPF systems may involve determining real-time simulations of a power distribution network using real-time measurements from various networked power distribution network components. As utility companies gradually upgrade their power distribution networks, these real-time capabilities may become more widespread. Currently, however, many power distribution networks may be only partially upgraded and may not be capable of supplying the real-time measurements to support complex DPF systems.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In an embodiment, a method includes determining a path between a power source and a tie switch in a feeder within a model of a power distribution network. The method also includes determining one or more ratings respectively associated with one or more transformers located on the path. The method also includes determining one or more loads respectively associated with the one or more transformers located on the path. The method also includes determining one or more available capacities respectively associated with the one or more transformers based, at least in part, upon the one or more ratings and the one or more loads respectively associated with the one or more transformers. The method also includes assigning an available capacity to the tie switch in the model based, at least in part, on the one or more available capacities respectively associated with the one or more transformers, such that the model indicates how much power may be supplied by the feeder, upon activation of the tie switch, to restore power to a portion of the power distribution network.

In another embodiment, an electronic device includes a storage configured to store a model of a power distribution network, wherein the model comprises one or more parameters of the power distribution network. The electronic device also includes data processing circuitry configured to determine an available capacity of a portion of a first feeder of the power distribution network to deliver power to a portion of a second feeder based, at least in part, on the one or more parameters in the stored model. The data processing circuitry is also configured to determine an estimate of a total load of the portion of the second feeder of the power distribution network based, at least in part, on the one or more parameters in the stored model. The data processing circuitry is also configured to compare the available capacity of the portion of the first feeder to the estimate of the total load of the portion of the second feeder. The data processing circuitry is also configured to determine that the portion of the first feeder is capable of supplying power to the portion of the second feeder when the available capacity of the portion of the first feeder is greater than or equal to the estimate of the total load of the portion of the second feeder. The data processing circuitry is also configured to an output device configured to output a user-perceptible indication that the portion of the first feeder should be used to restore power to the portion of the second feeder when it is determined that the first feeder is capable of supplying power to the portion of the second feeder.

In a third embodiment, an article of manufacture includes one or more computer-readable media at least collectively storing instructions executable by a processor of an electronic device, the instructions including instructions to determine an available capacity at a first tie switch of a first feeder in a power distribution network based, at least in part, on a model of the power distribution network. The instructions also include instructions to determine an estimate of total load of a portion of a second feeder in the power distribution network based, at least in part, on the model. The instructions also include instructions to recommend that the first tie switch supply power to the portion of the second feeder if the available capacity at the first tie switch is greater than or equal to the estimate of the total load of the portion of the second feeder.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating an embodiment of a power distribution transfer capacity calculator (DTC) system;

FIG. 2 is a schematic of an embodiment of a model of a power distribution network;

FIG. 3 is a flow diagram illustrating an embodiment of a process for determining whether a first feeder should supply power to a deenergized portion of a second feeder;

FIG. 4 is a flow diagram illustrating an embodiment of a process for determining the available capacity at a tie switch in a feeder; and

FIG. 5 is a flow diagram illustrating an embodiment of a process for determining an estimate of the total load of a portion of a feeder.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Power utility companies may manage different types of power distribution networks in different ways. For example, some power distribution networks incorporate “smart” components (e.g., power sources, transformers, tie switches, etc.) that may include sensing, data processing, and network communication circuitry. Such “smart” components may provide a control system with up-to-date information regarding the current state, performance, and operational parameters of the component. The control system may then, in turn, use the information received to make informed decisions regarding the operation of the power distribution network. In many cases, such a system may be referred to as a distribution power flow (DPF) simulation system, which can perform computer simulations of the power distribution network. Based on the DPF simulations, a utility company may undertake appropriate operational decisions.

However, not all power distribution networks are completely equipped with “smart” components. That is, some power distribution networks may not include any “smart” components at all, while some power distribution networks may employ a hybrid network having both “smart” and non-“smart” components. Hybrid networks may be common as power distribution networks are gradually upgraded to include more “smart” equipment over time.

Accordingly, when a control decision is to be made for a hybrid or completely non-“smart” power distribution network, there may be a dearth of up-to-date information for the components of the network. As such, the disclosed embodiments enable an operator to make informed decisions regarding the operation of the network based upon the recommendations of the power distribution transfer capacity calculator (DTC) system. The disclosed DTC system relies upon a simplified model of the power distribution network to enable the determination of aspects of the power distribution network (e.g., the available capacity and the load of portions of the network) using as little or as much information as is available for a particular network configuration. That is, the simplified model used by the disclosed DTC system embodiments may include at least a minimum amount of static information regarding the power distribution network (e.g., a relative location and power rating for each transformer), but may also incorporate up-to-date information from “smart” components in the power distribution network as well. By utilizing a model that incorporates all available information, the disclosed DTC system embodiments enable the determination of aspects of the power distribution network in a manner similar to “smart” power distribution networks, but without requiring a network of entirely “smart” equipment. As such, the disclosed embodiments may serve as an interim solution for power distribution networks as they are gradually updated to include more and more “smart” components.

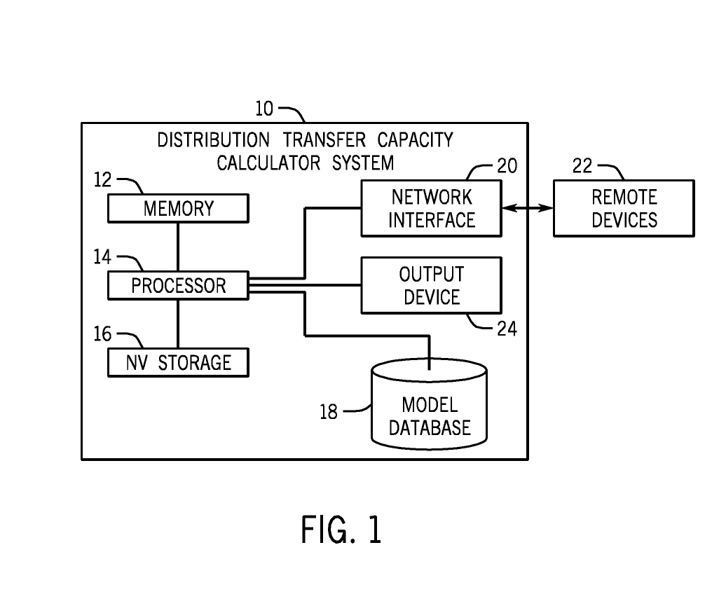

With the foregoing in mind, FIG. 1 illustrates an embodiment of a power distribution transfer capacity calculator (DTC) system 10 that enables the determination of aspects of a power distribution network using a model at least a minimal amount of information regarding the network. The system 10 may include a memory 12 (e.g., random access memory (RAM)) and a processor 14 for executing instructions (e.g., stored in the memory 12 or non-volatile (NV) storage 16, or received from a network interface 20) to calculate and determine aspects of the power distribution network. In certain embodiments, the system 10 may be a computer, such as a standard desktop, laptop, or tablet computer that can carry out the presently disclosed techniques. Accordingly, in certain embodiments, the processor 14 may be a computer's central processing unit. In other embodiments, the processor 14 may be a specialized processor, such as a field-programmable gate array (FPGA) processor, a programmable logic controller (PLC), or a graphics processing unit (GPU). Furthermore, the system 10 may include an output device 17 capable of displaying information and/or recommendations to the operator.

The DTC system 10 may include a model database 18, which includes information regarding the power distribution network. In certain embodiments, the model database 18 may be implemented as one or more files stored within NV storage 16. The information stored in the model database 18 may include, for example, the power ratings, loads, and relative positions of the various transformers in the power distribution network. The model database 18 may also include, for example, information regarding the properties (e.g., relative location, rating, state) of power sources, transmission lines, and switches of the power distribution network. The information stored within the model database 18 may initially be entered manually by an operator or acquired using a network interface 20 to communicate with remote devices 22.

Accordingly, the system 10 may be equipped with a network interface 20 that may be used to request and receive information from remote devices 22 (e.g., “smart” transformers, “smart” power sources, etc.), after which the information may be included in the model database 18 and/or the calculations performed by the processor 14 to determine aspects of the power distribution network. Furthermore, in certain embodiments, the system 10 may use the network interface 20 to request and receive information from a remote device 22 acting as a central repository for information pertaining to multiple power distribution networks (e.g., a model server) in order to populate the model database 18. In certain embodiments, the network interface 20 may include an Ethernet card, a modem, a wireless networking card, or other similar device to enable communication between the system 10 and the remote devices 22. The system 10 may also include an output device (e.g., a monitor, speaker, indicator light, etc.) such as may be used by the system 10 to inform the operator of the results of the determinations made by the processor 14 and/or the recommendations of the system 10. In certain embodiments, the system 10 may also utilize the network interface 20 to send information to remote devices 22 to inform a remote operator of the results of the determinations made by the processor 14 and/or the recommendations of the system 10.

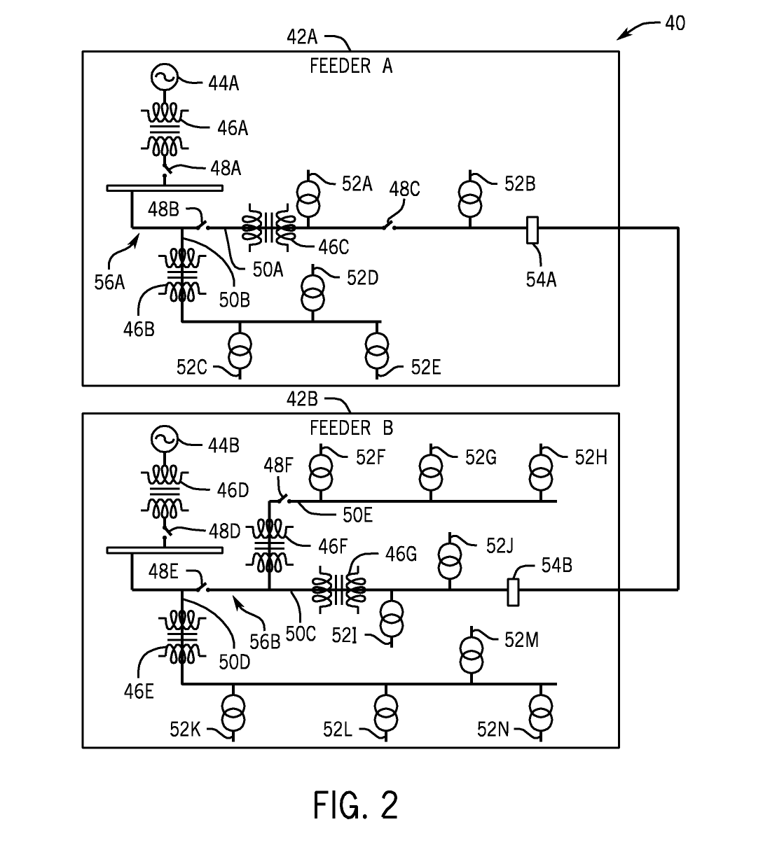

FIG. 2 illustrates an embodiment of a particular power distribution network 40. In an embodiment, the DTC system 10 may be used to determine aspects (e.g., the available capacity and the total load) of portions of the power distribution network 40 in order to advise an operator how to respond to outages within the network 40. Specifically, the illustrated power distribution network 40 of FIG. 2 illustrates two feeders: feeder 42A and feeder 42B. Each feeder (e.g., 42A or 42B) includes a power source 44 (e.g., power sources 44A and 44B). In certain embodiments, the power source 44 may be a power plant or power station that converts energy from chemical (e.g., coal, oil, natural gas, etc.), mechanical (e.g., wind or water turbines), solar (e.g., photovoltaic or solar-thermal), and/or nuclear energy sources into electricity to feed into the network 40. In certain embodiments, the power source 44 may be the only point in which a main transmission line from a power plant or power station ties into the feeder 42. In certain embodiments, when the DTC system 10 is determining the available capacity of a portion of a feeder 42, the system 10 may locate information (e.g., the load and the relative location) for a power source 44 by searching within the model database 18. In certain embodiments, the system 10 may, alternatively or additionally, request and receive the information (e.g., the load of the power source 44) from remote devices 22 (e.g., “smart” power source 44 or a model server) via network interface 20.

Each feeder 42 also includes a number of transformers 46 that are generally configured to receive electrical power at a first, generally higher, voltage, and to output the electrical power at a second, generally lower, voltage. For example, the power source 44A may supply the transformer 46A of the feeder 42A with electrical power at 30 kV. Accordingly, the transformer 46A may, in turn, output electrical power at 14 kV to the remainder of the feeder 42A. By further example, the transformer 46B may receive electrical power at 14 kV (after the voltage is initially stepped down at from 30 kV at transformer 46A) and subsequently output electrical power at 5 kV. A transformer 46 typically is assigned a particular rating at the time of manufacturing, and this rating is a measure of the maximum power output capacity of the transformer 46. That is, the rating indicates a transformer's capacity to transform (i.e., convert) electrical power from a first voltage to a second voltage, and this rating may be provided in kVA (i.e., kilovolt ampere) units. Another parameter of the transformer 46 is the load, or the amount of power that is consumed downstream of the transformer 46. It should be noted that while transformer ratings may typically be provided in kVA units, values for the load on the transformer 46 may be acquired in different units (e.g., kilowatts) that may be converted to kVA prior to performing the calculations described below. In an embodiment, when the DTC system 10 is determining the available capacity of a portion of a feeder 42, the system 10 may access a rating associated with each transformer 46, along with information regarding the relative location of the transformer 46 within the power distribution network 40, stored within the model database 18. In certain embodiments, the system 10 may, additionally or alternatively, request and receive the rating and relative location information from remote devices 22 (e.g., “smart” transformers or a model server) via network interface 20 for at least a portion of the transformers 46 in the power distribution network 40.

Additionally, each feeder 42 also may include several switches 48. These switches (e.g., 48A, 48B, 48C, 48D, 48E, and 48F) may be positioned at various points along the power distribution network 40. For example, the switch 48A may lie between the power source 44A and the remainder of feeder 42A. The switches 48 may be opened to sequester the portions or segments of the network 40, illustrated as network segments 50 (e.g., 50A and 50B), on either side of the switch 48. For example, switch 48B may be opened such that the network segment 50A is no longer in electrical contact with the network segment 50B. Generally, a switch 48 may be closed so as to provide a conductive path across the switch 48 unless there is an issue requiring that a portion of the feeder 42 be intentionally isolated or deenergized.

As mentioned briefly above, in certain embodiments, when the DTC system 10 is determining a path between two components in the power distribution network 40, the system 10 may locate information regarding the state (e.g., open or closed) of a switch 48 from the model database 18. The state of the switch 48 in the model database 18 may be set, for example, manually by the operator. In certain embodiments, the DTC system 10 may, additionally or alternatively, request and receive information regarding the state of a switch 48 from a remote device 22 (e.g., a “smart” switch 48 or a model server) when determining a path between two components in the power distribution network 40.

In addition, each feeder 42 may also include several load transformers 52 (e.g., 52A, 52B, 52C, 52D, 52E, 52F, 52G, 52H, 52I, 52J, 52K, 52L, 52M, and 52N) coupled to various portions of the power distribution network 40. A load transformer 52 serves a similar role to the larger transformers 46 in that they are configured to receive electrical power at a first voltage and output electrical power at a different voltage. However, a load transformer 52 typically is responsible for stepping down the voltage from around 8-14 kV to about 1 kV, putting the load transformer 52 closer to the actual power consumer. For example, a load transformer 52 may be responsible for outputting 1 kV to an entire street of houses, and the voltage may be appropriately stepped down to 120 V or 220 V, for example, at each house on the street for consumption.

Accordingly, as illustrated in the embodiment of FIG. 2, a model stored in the model database 18 that models the power distribution network 40 may not indicate individual loads (e.g., power consumers) located downstream of the load transformer 52. Rather, the model may use the load transformers 52 to represent all underlying or downstream loads. For example, if the load transformer 52A were responsible for powering ten houses, each consuming 5 kVA, the model database 18 may store a value of 50 kVA for the total load on the load transformer 52A rather than including information for each underlying load. In certain embodiments, when the DTC system 10 is determining the load on a transformer or the load of a deenergized portion of a feeder 42, the system 10 may locate information regarding the load for each load transformer 52 from the model database 18. In certain embodiments, the DTC system 10 may, additionally or alternatively, request and receive information regarding the load for a portion of the load transformers 52 from a remote device 22 (e.g., a “smart” load transformer 52 or a model server).

A specific type of switch that may be present in each feeder 42 is a tie switch 54. Like the other switches (e.g., 48A, 48B, 48C, 48D, 48E, and 48F), the tie switches (e.g., tie switch 54A or 54B) may be opened to sequester the portions of the power distribution network 40 on either side of the tie switch 54 and may be closed to provide a conductive path across the tie switch. However, the tie switches 54A and 54B are positioned such that they may sequester the feeder 42A from the feeder 42B when they are in the open position. In general, unlike other switches in the network 40, the tie switches 54A and 54B typically remain open until an issue in the power distribution network 40 (e.g., a fault) motivates the closing of the tie switches 54A and 54B. Closing the tie switches 54A and 54B may thus cause one feeder (e.g., the feeder 42A) to supply power to a deenergized portion of another feeder (e.g., the feeder 42B). As such, two parameters of a tie switch 54 are the state (e.g., open or closed) and the available capacity of the feeder 42 at the tie switch, for which the calculation is described below. In certain embodiments, the DTC system 10 may locate information about the state and the relative location of a tie switch 54 from the model database 18. In certain embodiments, the DTC system 10 may, additionally or alternatively, request and receive information regarding the state of a tie switch 54 from a remote device 22 (e.g., a “smart” tie switch 54 or a model server). In certain embodiments, the system 10 may store the available capacity of the feeder 42 at the tie switch 54 in the model database 18 after it has been determined as described below.

As mentioned above, a fault 56 may sometimes occur within one of the feeders 42 (e.g., 42A). In response, the switch 54[A/B] may be opened and the feeder 42A may become deenergized. Simply closing the tie switch 54[A/B] at a later time to reenergize one feeder 42 (e.g., 42A) of the power distribution network 40 could overwhelm the power-supplying feeder 42 (e.g., 42B) under certain conditions. As such, before a tie switch 54 (e.g., 54[A/B]) is closed to reenergize a portion of the power distribution network 40, the DTC system 10 may determine whether the power-supplying feeder 42 (e.g., 42B) has the available capacity to power the deenergized portion of the second feeder 42.

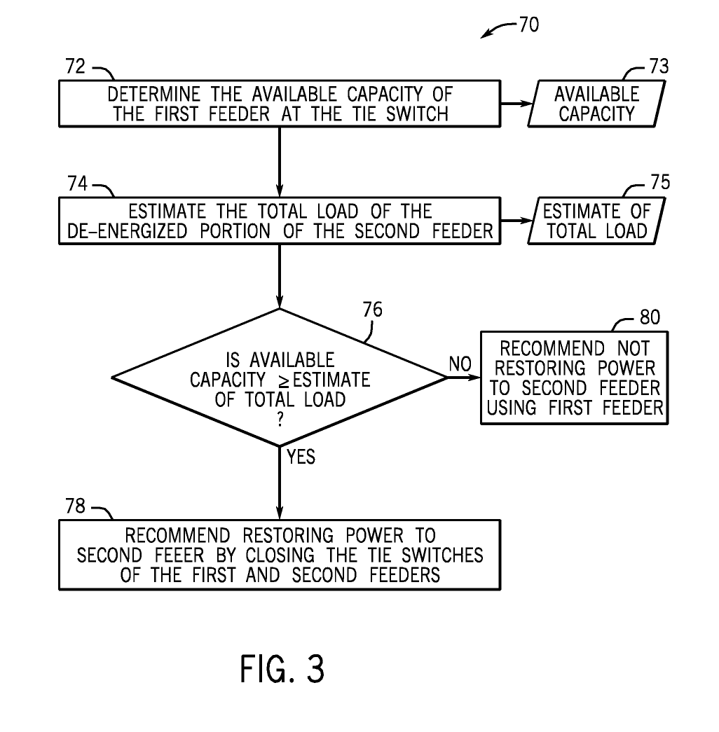

Accordingly, FIG. 3 illustrates an embodiment of a high-level process 70 by which the DTC system 10 may make such a determination. The process 70 begins with the DTC system 10 determining (block 72) an available capacity 73 of the first feeder 42 at the tie switch 54. Next, the system 10 may estimate (block 74) a total load 75 of the deenergized portion of the second feeder 42. The DTC system 10 may determine if (block 76) the available capacity 73 of the first feeder 42 at the tie switch 54 is greater than or equal to the estimated total load 75 of the deenergized portion of the second feeder 46. If the available capacity 73 meets or exceeds the estimated total load 75, the system 10 may recommend (block 78) restoring power to the deenergized portion of the second feeder by closing the tie switches 54 that separate the feeders. However, if the available capacity 73 is less than the estimated total load 75 of the deenergized portion of the second feeder 42, the system 10 may recommend (block 80) not restoring power and leaving the tie switches 54 open.

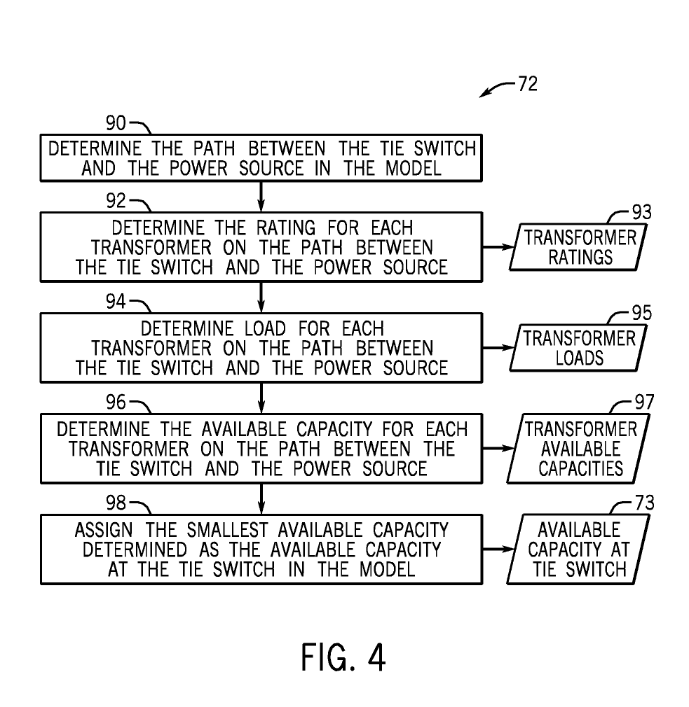

As illustrated in FIG. 3, block 72 of the process 70 involves determining the available capacity 73 of the first feeder 42 at the tie switch 54. Accordingly, FIG. 4 is a flow diagram that depicts an embodiment of a process 72 by which the DTC system 10 may determine the available capacity 73 of a feeder 42 at the tie switch 54. More specifically, the system 10 may determine the available capacity 73 of the portion of the feeder 42 that lies between the power source 44 and the tie switch 54. Accordingly, the process 72 begins with the system 10 determining (block 90) the path between the tie switch 54 and the power source 44 in the feeder 42. For example, the system 10 may systematically search the model database 18 until a path may be determined that connects the tie switch 54A to the power source 44A.

Once the path between the power source 44 and the tie switch 54 has been determined, the DTC system 10 may then determine (block 92) transformer ratings 93 for each transformer 46 located on the path. For example, in the embodiment illustrated in FIG. 2, transformers 46A and 46C are located on the path between the tie switch 54A and the power source 44A in feeder 42A. In certain embodiments, the system 10 may determine the transformer ratings 93 by looking up the rating for each transformer 46 in the model database 18. For example, the system 10 may search the model database 18 and determine that the transformer 46A has a rating of 150 kVA and transformer 46C has a rating of 75 kVA. In certain embodiments, the system 10 may, additionally or alternatively, determine the rating for at least a portion of the transformers 46 using the network interface 20 to request and receive rating information from a remote device 22 (e.g., a “smart” transformer 46 or remote model server).

Next, the DTC system may determine (block 94) loads 95 for each transformer 46 on the path between the tie switch 54 and the power source 44. While, in certain embodiments, load information for each of the load transformers 54 may be located within the model database 18, in other embodiments, at least a portion of the load information for each transformer 54 may be requested and received from a remote device 22 (e.g., a “smart” load transformer 52 or a model server). For example, in determining the load for transformer 46A, the load for each of the load transformers 52A, 52B, 52C, 52D, and 52E in the feeder 42A may be determined (e.g., located in the model database 18) and added together. By further example, in determining the load for transformer 46B, only the loads for load transformers 52C, 52D, and 52E may be determined and added together. That is, if the transformer loads 95 for load transformers 52A, 52B, and 52C were determined to be 50 kVA, 75 kVA, and 50 kVA, respectively, the total downstream load for transformer 46B may be determined by DTC system 10 to be 175 kVA.

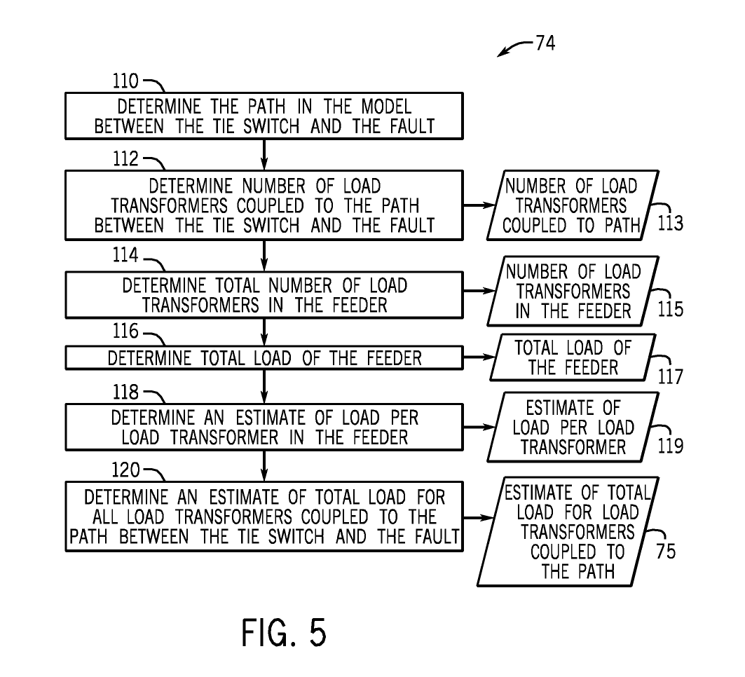

Alternatively, in certain embodiments, the transformer loads 95 for each of the load transformers 52 may not be known when attempting to determine the downstream load 95 for each transformer 46 on the path. As such, the DTC system 10 may, in certain embodiments, estimate the loads of load transformers 52 by assuming that all of the load transformers 52 equally contribute to the total load of the feeder 42. Accordingly, the DTC system 10 may divide the total load of the feeder 42 (e.g., from the model database 18 or a “smart” power source 44) by the total number of load transformers 52 present in the feeder 42 to arrive at an estimate for the load of the load transformer 52 in the feeder 42. To determine the load 95 for a particular transformer 46, the estimate for the load of the load transformers 52 may be multiplied by the number of load transformers 52 located downstream of each transformer 46. The system 10 may determine the total load of the deenergized portion of a feeder 42 using a similar load estimate, as described below in reference to FIG. 5.

The DTC system 10 may determine (block 96) an available capacity 97 for each transformer 46 in the path between the tie switch 54 and the power source 44. To determine the available capacity 97 of each transformer 46, the determined transformer load 95 may be subtracted from the determined transformer rating 93 for each transformer 46. For example, the system 10 may determine (e.g., from the model database 18 or from remote devices 22) that the transformer 46A has a rating of 200 kVA and a downstream load of 175 kVA. Accordingly, the system 10 may determine that the available capacity for the transformer 46A is 25 kVA. In certain embodiments, the model database 18 may store the determined each transformer available capacity 97, while in other embodiments available capacities 97 may exist as computed fields that are calculated on-demand from stored rating and load information in the model database 18.

Thereafter, the DTC system 10 assigns (block 98) the smallest available capacity value out of the transformer available capacities 97 for the transformers 46 in the path between the tie switch 54 and the power source 44 as the available capacity 73 at the tie switch 54. That is, the transformer 46 in the path having the smallest available capacity will be the limiting factor in the amount of additional power that may be supplied through the path. For example, the path between a tie switch 54A and a power source 44 may include two transformers 46A and 46C with available capacities of 100 kVA, and 25 kVA, respectively. As such, the tie switch 54A may be assigned an available capacity value 73 of 25 kVA in the model database 18.

Recalling the process 70 illustrated in FIG. 3, once the available capacity 73 of the tie switch 54 of the first (energized) feeder (e.g., feeder 42A) has been determined, the DTC system 10 estimates (block 74) the total load 75 of the deenergized portion of the second feeder (e.g., feeder 42B). FIG. 5 illustrates an embodiment of a process 74 by which the system 10 may determine an estimate for this total load 75. The process 74 begins with the DTC system 10 determining (block 110) a path between the tie switch 54B and the fault 56B. The fault 56B in the feeder 42B may be any issue (e.g., a downed transmission line, a failed transformer, etc.) that may prevent power from going beyond a particular point in the power distribution network 40. The deenergized portion of the feeder 42B that may be restored by the closing of the tie switch 54B extends from the tie switch 54B to the fault 56B. To determine the path between such a fault 56B and the tie switch 54B, the DTC system 10 may, for example, systematically search the model database 18 until a path may be determined that connects the tie switch 54B and the fault 56B.

The DTC system 10 may determine (block 112) a number 113 of load transformers 52 that are coupled to the path between the tie switch 54B and the fault 56 in the deenergized feeder 42B. In certain embodiments, the system 10 may determine the number 113 of load transformers 52 by counting, in the model database 18, each load transformer 52 coupled to the path. In certain embodiments, the system 10 may, additionally or alternatively, request and receive information regarding the number 113 of load transformers 52 coupled to the path from a remote device 22 (e.g., a model server).

The DTC system 10 may also determine (block 114) a total number 115 of load transformers 52 in the feeder 42B. In certain embodiments, the system 10 may determine the total number 115 of load transformers 52 by counting, in the model database 18, each load transformer 52 in the feeder 42B. In certain embodiments, the model database 18 may store the total number 115 of load transformers 52 present within a feeder 42B such that this value may be accessed and used rather than counting the individual load transformers.

Next, the DTC system 10 may determine (block 116) the total load 117 of the feeder 42B. In certain embodiments, the system 10 may determine the total load 117 of the feeder 42B by looking up the load for the power source 44B of the feeder 42B in the model database 18. In an embodiment, the DTC system 10 may request and receive the load of the power source 44 from a remote device 22 (e.g., a “smart” power source 44 or a model server) via the network interface 20 to determine the total load 117 of the feeder 42B. In an embodiment in which all of the power for the feeder 42B passes through a particular transformer (e.g., transformer 46D), the system 10 may determine the total load 117 for the feeder 42B by determining the load of the particular transformer 46D from the model database 18 or from a remote device 22 (e.g., a “smart” transformer 46 or a model server) via the network interface 20.

The DTC system 10 may use the total load 117 and the total number 115 of load transformers 52 in the feeder 42B to determine (block 118) an estimate 119 of the load per load transformer 52. For example, in an embodiment, the DTC system 10 may equally divide the total load 117 of the feeder 42 by the total number 115 of load transformers 52 in the feeder 42B to yield an estimate 119 of the load per load transformer 52 in the feeder 42B. For example, if the total load 117 of the feeder 42B is determined to be 100 kVA, and feeder 42B contains five load transformers 52, the determined estimate of the load per load transformer 119 may be 20 kVA per load transformer.

The DTC system 10 thereafter may determine (block 120) the estimate for the total load 75 of the load transformers 52 coupled to the path between the tie switch 54B and the fault 56B (i.e., the deenergized portion of the feeder 42). For example, the system 10 may determine this estimate by multiplying the number of load transformers 52 determined to be coupled to the path (i.e., value 113) by the estimate of the load per load transformer 52 (i.e., value 119). In another embodiment, instead of estimating the total load for the deenergized portion of the feeder using the process 74, the system 10 may instead determine a more exact value for the total load for the deenergized portion of the feeder 42B by summing the individual loads for each load transformer 52 as received from remote devices 22 (e.g., “smart” load transformers 52) via the network interface 20.

As an example of the entire process 70, turning once again to the embodiment of FIG. 2, a fault 56A may occur within the feeder 42A. As such, the DTC system 10 may perform the process 70 to determine whether or not feeder 42B should be used to supply power to the deenergized network segments 50A and 50B of the feeder 42A. Accordingly, the DTC system 10 may analyze the feeder 42B in the model database 18 to determine (block 72) the available capacity 73 of the feeder 42B at the tie switch 54B, as illustrated in FIGS. 3 and 4. As such, the system 10 may determine (block 90) the path between the tie switch 54B and the power source 44B, and then determine (block 92) a rating of 250 kVA for transformer 46C as well as a rating of 200 kVA for transformer 46G, as illustrated in FIG. 4. Then, the system 10 may determine (block 94) the downstream load 95 for transformer 46C, which would include the loads of all load transformers (e.g., 52F, 52G, 52H, 52I, 52J, 52K, 52L, 52M, and 52N) in feeder 42B, to be 150 kVA. The system 10 may also determine (block 94) the downstream load 95 for transformer 46G, which would include the loads of load transformers 52I and 52J, to be 50 kVA. Next, the system 10 may determine (block 96) the available capacity 97 of the transformer 46C to be 100 kVA and the available capacity 97 of the transformer 46G to be 150 kVA. Accordingly, the system 10 may assign, in the model database 18, a value of 100 kVA as the available capacity 73 at the tie switch 54B. The system 10 may then estimate (block 74) the total load 75 of the deenergized portion of feeder 42A, as illustrated in FIGS. 3 and 5. Accordingly, the system 10 may determine (block 110) a path between the fault 56A and the tie switch 54A in feeder 42A to include network segments 50A and 50B, as illustrated in FIGS. 2 and 5. Then, the system 10 may determine (block 114) the number 115 of load transformers (e.g., 52A, 52B, 52C, 52D, and 52E) in feeder 42A to be five, and the total load 117 for the feeder 42A to be 80 kVA (block 116). Next, the system 10 may determine (block 118) an estimate 119 for the load per load transformer (e.g., 52A, 52B, 52C, 52D, and 52E) to be 16 kVA per load transformer. Then, the system 10 may determine (block 120), since all load transformers (e.g., 52A, 52B, 52C, 52D, and 52E) are coupled to the path between the fault 56A and the tie switch 54A, that the estimated total load 75 of the deenergized portion of feeder 42A is 80 kVA. Then, having the available capacity 73 of the tie switch 54B and the estimated total load 75 for the deenergize portion of feeder 42A, the values (e.g., 100 kVA and 80 kVA, respectively), the system 10 may determine (block 76) that the available capacity 73 of the tie switch 54B is greater than the estimated total load 75 for the deenergized portion of feeder 42A, as illustrated in FIG. 3. Accordingly, the system 10 may recommend (block 78) restoring power to feeder 42A by closing tie switches 54A and 54B.

As an additional example of the entire process 70, turning once again to the embodiment of FIG. 2, a fault 56B may instead occur within the feeder 42B. As such, the DTC system 10 may perform the process 70 to determine whether or not feeder 42A should be used to supply power to the deenergized network segments 50C and 50E of the feeder 42B. Accordingly, the DTC system 10 may analyze the feeder 42B in the database model 18 to determine (block 72) the available capacity 73 of the feeder 42A at the tie switch 54A, as illustrated in FIGS. 3 and 4. As such, the system 10 may determine (block 90) the path between the tie switch 54A and the power source 44A, and then determine (block 92) a rating of 350 kVA for transformer 46A as well as a rating of 150 kVA for transformer 46C, as illustrated in FIG. 4. Then, the system 10 may determine (block 94) the downstream load 95 for transformer 46A, which would include the loads of all load transformers (e.g., 52A, 52B, 52C, 52D, and 52E) in feeder 42A, to be 200 kVA. The system 10 may also determine (block 94) the downstream load 95 for transformer 46C, which would include the loads of load transformers 52A and 52B, to be 75 kVA. Next, the system 10 may determine (block 96) the available capacity 97 of the transformer 46A to be 150 kVA and the available capacity 97 of the transformer 46C to be 75 kVA. Accordingly, the system 10 may assign, in the model database 18, a value of 75 kVA as the available capacity 73 at the tie switch 54B. The system 10 may then estimate (block 74) the total load 75 of the deenergized portion of feeder 42B, as illustrated in FIGS. 3 and 5. Accordingly, the system 10 may determine (block 110) a path between the fault 56B and the tie switch 54B in feeder 42B to include network segments 50C and 50E, as illustrated in FIGS. 2 and 5. Then, the system 10 may determine (block 114) the number 115 of load transformers (e.g., load transformers 54F, 54G, 54H, 54I, 54J, 54K, 54L, 54M, and 54N) in feeder 42B to be nine, and the total load 117 for the feeder 42B to be 180 kVA (block 116). Next, the system 10 may determine (block 118) an estimate 119 for the load per load transformer (e.g., 52A, 52B, 52C, 52D, and 52E) to be 20 kVA per load transformer 52. Then, the system 10 may determine (block 120), since five of the load transformers (e.g., 52F, 52G, 52H, 52I, 52J) are coupled to the path between the fault 56B and the tie switch 54B, that the estimated total load 75 of the deenergized portion of feeder 42A is 100 kVA. Then, having the available capacity 73 of the tie switch 54A and the estimated total load 75 for the deenergized portion of feeder 42B, the values (e.g., 75 kVA and 100 kVA, respectively), the system 10 may determine (block 76) that the available capacity 73 of the tie switch 54B is less than the estimated total load 75 for the deenergized portion of feeder 42A, as illustrated in FIG. 3. Accordingly, the system 10 may recommend (block 78) not restoring power to feeder 42B using feeder 42A.

Technical effects of the present disclosure include enabling an operator to make informed decisions regarding the operation of the network based upon the recommendations of the disclosed power distribution transfer capacity calculator (DTC) system 10. The disclosed DTC system 10 enables the determination of aspects of the power distribution network (e.g., the available capacity and the load of portions of the network) and may make recommendations using as little or as much information as is available for a particular network configuration. That is, the disclosed DTC system 10 may consider both static information regarding the power distribution network (e.g., a relative location and power rating for each transformer) and up-to-date information from “smart” components in the power distribution network. By utilizing a model that incorporates all available information, the disclosed DTC system embodiments enable the determination of aspects of the power distribution network in a manner similar to “smart” power distribution networks, but without requiring a network of entirely “smart” equipment. As such, the disclosed embodiments may serve as an interim solution for power distribution networks as they are gradually migrated toward “smart” components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method, comprising:
determining a path between a power source and a tie switch in a feeder within a model of a power distribution network;
determining one or more ratings respectively associated with one or more transformers located on the path;
determining one or more loads respectively associated with the one or more transformers located on the path;
determining one or more available capacities respectively associated with the one or more transformers based, at least in part, upon the one or more ratings and the one or more loads respectively associated with the one or more transformers; and
assigning an available capacity to the tie switch in the model based, at least in part, on the one or more available capacities respectively associated with the one or more transformers, such that the model indicates how much power may be supplied by the feeder, upon activation of the tie switch, to restore power to a portion of the power distribution network.

2. The method of claim 1, wherein determining the one or more ratings respectively associated with the one or more transformers comprises locating the one or more ratings respectively associated with each of the one or more transformers from the model.

3. The method of claim 1, wherein determining the one or more ratings respectively associated with the one or more transformers comprises receiving the one or more ratings respectively associated with each of the one or more transformers from each of the one or more transformers over a network connection.

4. The method of claim 1, wherein determining the one or more loads respectively associated with the one or more transformers comprises locating and summing one or more loads in the model that are downstream from each of the one or more transformers.

5. The method of claim 1, wherein determining the one or more loads respectively associated with the one or more transformers comprises receiving the one or more loads respectively associated with the one or more transformers from each of the one or more transformers over a network connection.

6. The method of claim 1, wherein determining the one or more available capacities respectively associated with the one or more transformers comprises subtracting the one or more respectively associated loads from the one or more respectively associated ratings for each of the one or more transformers.

7. An electronic device, comprising:
a storage configured to store a model of a power distribution network, wherein the model comprises one or more parameters of the power distribution network;
data processing circuitry configured to:
determine an available capacity of a portion of a first feeder of the power distribution network to deliver power to a portion of a second feeder of the power distribution network based, at least in part, on the one or more parameters in the stored model;
determine an estimate of a total load of the portion of the second feeder based, at least in part, on the one or more parameters in the stored model;
compare the available capacity of the portion of the first feeder to the estimate of the total load of the portion of the second feeder; and
determine that the portion of the first feeder is capable of supplying power to the portion of the second feeder when the available capacity of the portion of the first feeder is greater than or equal to the estimate of the total load of the portion of the second feeder; and
an output device configured to output a user-perceptible indication that the portion of the first feeder should be used to restore power to the portion of the second feeder when it is determined that the first feeder is capable of supplying power to the portion of the second feeder.

8. The electronic device of claim 7, wherein the one or more parameters of the power distribution network in the stored model comprise one or more of transformer power ratings, transformer loads, transformers locations, switch locations, switch states, tie switch locations, tie switch states, power source locations, total load for the feeder, number of load transformers in the feeder, and load transformer loads.

9. The electronic device of claim 7, wherein the data processing circuitry is configured to determine the available capacity of the portion of the first feeder by:
locating, in the stored model, a path connecting a power source and a tie switch in the first feeder;
locating, in the stored model, one or more transformers on the path between the power source and the tie switch;
determining one or more ratings respectively associated with the one or more transformers;
determining one or more loads respectively associated with the one or more transformers;
determining one or more available capacities respectively associated with the one or more transformers based, at least in part, upon the one or more ratings and the one or more loads respectively associated with the one or more transformers; and
determining the available capacity of the portion of the first feeder to deliver power to the portion of the second feeder based, at least in part, on the one or more available capacities respectively associated with the one or more transformers.

10. The electronic device of claim 9, wherein determining the one or more ratings respectively associated with the one or more transformers comprises receiving the one or more ratings respectively associated with each of the one or more transformers from each of the one or more transformers over a network connection.

11. The electronic device of claim 9, wherein determining the one or more loads respectively associated with the one or more transformers comprises locating and summing one or more loads in the stored model that are downstream from each of the one or more transformers.

12. The electronic device of claim 9, wherein determining the one or more available capacities respectively associated with the one or more transformers comprises subtracting the one or more respectively associated loads from the one or more respectively associated ratings for each of the one or more transformers.

13. The electronic device of claim 7, wherein determining the estimate of the total load of the portion of the second feeder comprises:
locating, in the stored model, the portion of the second feeder, wherein the portion of the second feeder is defined by a path between a fault and a tie switch in the second feeder;
determining a number of load transformers in the second feeder coupled to the path;
determining a total number of load transformers in the second feeder;
determining a total load of the second feeder;
determining an estimate of the load per load transformer for the second feeder; and
determining the estimate of the total load of the portion of the second feeder based, at least in part, on the estimate of the load per load transformer and the number of load transformers on the path, wherein the portion of the second feeder extends between the fault and the tie switch in the second feeder.

14. The electronic device of claim 13, wherein determining the total load of the second feeder comprises receiving a total power usage from a power source of the second feeder via a network connection.

15. An article of manufacture comprising:
one or more computer-readable media at least collectively storing instructions executable by a processor of an electronic device, the instructions comprising:
instructions to determine an available capacity at a first tie switch of a first feeder in a power distribution network based, at least in part, on a model of the power distribution network;
instructions to determine an estimate of total load of a portion of a second feeder in the power distribution network based, at least in part, on the model; and
instructions to recommend that the first tie switch supply power to the portion of the second feeder if the available capacity at the first tie switch is greater than or equal to the estimate of the total load of the portion of the second feeder.

16. The article of manufacture of claim 15, wherein the instructions to determine the available capacity of the first tie switch comprise:
instructions to locate a path in the model between the first tie switch and a power source in the first feeder;
instructions to determine a rating for each of one or more transformers located on the path;
instructions to determine a load for each of the one or more transformers;
instructions to determine an available capacity for each of the one or more transformers based upon the rating and the load of the one or more transformers;
instructions to calculate the available capacity of the portion of the first feeder based, at least in part, on the available capacity of the one or more transformers.

17. The article of manufacture of claim 16, wherein the instructions to determine the rating for each of the one or more transformers comprises instructions to locate the rating from the stored model or receive the rating over a network connection for each of the one or more transformers.

18. The article of manufacture of claim 16, wherein the instructions to determine the load for each of the one or more transformers comprises locating and summing one or more downstream loads from the model for each of the one or more transformers.

19. The article of manufacture of claim 16, wherein the instructions to determine the available capacity for each of the one or more transformers comprises subtracting the load from the rating for each of the one or more transformers.

20. The article of manufacture of claim 15, wherein the instructions to determine the estimate of the total load comprises:
instructions to determine the portion of the second feeder, wherein the portion of the second feeder is defined by a path in the model between a fault and a second tie switch in the second feeder;
instructions to determine a number of load transformers in the second feeder coupled to the path;
instructions to determine a total number of loads in the second feeder;
instructions to determine a total load of the second feeder;
instructions to calculate an estimate of load per load transformer for the second feeder; and
instructions to determine the estimate of total power usage of the portion of the second feeder based, at least on part, on the estimate of a load per load transformer and the number of load transformers coupled to the path.
